(19) United States
(12) Patent Application Publication
(10) Pub. No.: US 2010/0122864 A1
(43) Pub. Date: May 20, 2010

(54) Hybrid hydraulic drive system for all terrestrial vehicles, with the hydraulic accumulator as the vehicle chassis

(76) Inventor: Allan Rosman, Calabasas, CA (US)

Correspondence Address: Allan Rosman, 4004 Schuylkill Dr., Calabasas, CA, 91302, US

(21) Appl. No.: 12/313,046

(22) Filed: Nov. 17, 2008

(51) Int. Cl. B60W 10/24; F15B 1/033

(52) U.S. Cl. 180/165; 60/414

(57) ABSTRACT

A new hybrid hydraulic drive system for all types of terrestrial vehicles, including vehicles running on rails, using as prime mover any of the ICE (internal combustion engine) available or turbine, battery propulsion, electric motors, fuel cells, etc. One special variable hydraulic pump connected to the prime mover acts as a “power integrator”, receiving hydraulic power from the accumulator and mechanical power from the prime mover, to supply the desired flow and pressure to the hydraulic motors during operation. A second variable pump, reloads the accumulator with the remnant power available, if any, during the whole cycle. The accumulator is quite large and it is also used as the chassis for all terrestrial vehicles. The braking energy is returned to the accumulator. The whole vehicle is controlled by electronics, and in one embodiment, using only one joystick or pedal to control speed, direction, acceleration, braking and in some cases including steering.

### CROSS-REFERENCE TO RELATED APPLICATIONS

International classification . . . B60K 3/00; B60K 6/12; B60K 6/02; B60K 6/00; B60K 17/00; B60T 8/64; B62M 1/10; F15B 1/02; F16D 31/02; F04B 49/00; G06F 17/00

U.S. Cl . . . 180/165, 105/96.2, 105/238.1 180/365; 180/307,367,303/152; 60/408, 413, 414,415, 416, 418, 448, 449; 701/69; 903/941

Field of classification search . . . 105/96.2; 180/165, 180/365; 180/305, 306, 307,367,303,152; 280/212, 216; 303/112, 303/152, 303/113, 1, 10, 11, 413, 414, 416, 60/408, 409,413, 414, 416, 418,448,449; 701/69; 903/941

### REFERENCES CITED

### U.S. PATENT DOCUMENTS

| | | Inventor's | |
|---|---|---|---|
| US patent No | Date issued | name | Classification |
| 1,349,924 | August 1920 | Swanson | 180/165 |
| 1,902,124 | March 1933 | Halloran | 180/165 |
| 3,680,313 | August 1972 | Brundage | 60/460 |
| 3,892,283 | July 1975 | Johnson | 180/165 |
| 3,913,453 | October 1975 | Parquet | 60/493 X |
| 4,077,211 | March 1978 | Fricke | 60/428 |
| 4,098,083 | July 1978 | Carman | 60/484 |
| 4,098,144 | July 1978 | Besel | 74/661 |
| 4,132,283 | January 1979 | McCurry | 180/165 |
| 4,215,545 | August 1980 | Morello | 60/414 X |
| 4,227,587 | October 1980 | Carman | 180/165 |
| 4,351,409 | September 1982 | Malik | 180/165 |
| 4,356,773 | November 1982 | van Eyken | 105/238.1 |
| 4,387,783 | June 1983 | Carman | 180/168 |
| 4,592,454 | June 1983 | Michel | 192/3.23 |
| 4,741,410 | May 1988 | Tunmore | 180/165 |
| 4,745,745 | May 1988 | Hagin | 60/413 |
| 4,754,603 | July 1988 | Rosman | 60/413 |
| 4,760,697 | August 1988 | Heggie | 60/408 |
| 4,825,774 | May 1982 | Tani | 105/141 |
| 4,964,345 | October 1990 | Porel | 105.96.2 |
| 4,986,383 | January 1991 | Evans | 180/165 |
| 5,024,489 | June 1991 | Tanaka | 303/3 |
| 5,088,041 | February 1992 | Tanaka | 701/70 |
| 5,495,912 | March 1996 | Gray | 180/165 |
| 5,505,527 | April 1996 | Gray | 60/413 |
| 5,545,928 | August 1996 | Kotani | 290/40C |
| 5,579,640 | December 1996 | Gray | 60/413 |
| 5,794,734 | August 1998 | Fahl | 180/165 |
| 5,887,674 | March 1999 | Gray | 180/307 |
| 6,109,384 | August 2000 | Bromley | 180/242 |
| 6,170,587 | January 2001 | Bullock | 180/69.6 |
| 6,223,529 | May 2001 | Achten | 60/416 |
| 6,311,797 | November 2001 | Hubbard | 180/165 |
| 6,378,444 | April 2002 | Dastas | 105/396 |
| 6,629,573 | October 2003 | Perry | 180/54.1 |
| 6,719,080 | April 2004 | Gray | 180/165 |
| 6,793,029 | September 2004 | Ching | 60/413 |
| 6,834,737 | December 2004 | Boxham | 180/165 |
| 6,871,599 | March 2005 | Okuno | 105/238.1 |
| 7,100,723 | September 2006 | Roethler | 180/165 |
| 7,146,266 | December 2006 | Teslak | 701/69 |
| 7,147,078 | December 2006 | Teslak | 180/305 |
| 7,147,239 | December 2006 | Teslak | 280/306 |
| 7,232,192 | June 2007 | Teslak | 303/152 |
| 7,263,424 | August 2007 | Motoyama | 701/69 |
| 7,273,122 | September 2007 | Rose | 180/165 |
| 7,311,163 | December 2007 | Oliver | 180/165 |
| 7,401,464 | July 2008 | Yoshino | 60/414 |
| 7,409,826 | August 2008 | Epshteyn | 60/414 |
| 7,415,823 | August 2008 | Iwaki | 60/487 |
| 7,419,025 | September 2008 | Ishii | 180/242 |
| 7,426,975 | September 2008 | Toyota | 180/165 |
| 7,444,809 | November 2008 | Smith | 60/413 |
| 2004/0182632 | September 2004 | Hasegawa | 180/307 |
| 2007/0227802 | October 2007 | O'Brien II | 180/307 |
| 2008/0093152 | April 2008 | Gray | 180/307 |

### BACKGROUND OF THE INVENTION

1. Field of the Invention

The present invention relates to a series hybrid hydraulic drive system than can be applied with advantage to all terrestrial vehicles, including Industrial, commercial and military applications and eventually to passenger vehicles. The prime mover is used to its maximum capacity when running, and reloading of the accumulator occurs when braking and/or when the prime mover is running.

2. Description of Prior Art

Hybrid Hydraulic—regenerative-drive systems are known and have been applied to motor vehicles in the past. Parallel hydraulic systems are available and have been successful in getting the braking energy back to the accumulator for future use to accelerate the vehicle with acceptable energy savings.

The parallel hydraulic system is used as an add-on on vehicles and does not solve the full energy consumption issue of those vehicles.

The series hybrid hydraulic system goes beyond the parallel system, but lacks a good and precise flow control-speed-and has not solved, at low cost, the recharge of the accumulator using the extra power of the prime mover when available.

Both solutions have a very large handicap: steel accumulators weigh more than 50 times the weight of a lead-acid battery per unit of stored energy. When fiber made accumulators are used, the weight differential is still 12 to 1, but the price skyrockets. Hence all accumulators used for present hybrid hydraulic applications are quite small and usable only for short cycles, mainly for brake energy recuperation.

This issue does not allow for those systems to stop the engine when the accumulator is full, as the vehicle will only run for several seconds with the energy content of the accumulator. The present hydraulics are not prepared to allow for this operating mode.

The intention of this invention is to overcome the limitations of the prior art by using a simpler and less expensive system, as well being able to dramatically increase the efficiency of all terrestrials vehicles and cut substantially their emissions.

### BRIEF SUMMARY OF THE INVENTION

A hybrid hydraulic system whose objective is to change the economic and technical obstacles confronting hydraulics and its use in terrestrial vehicles, adding benefits not available with the prior art.

The use of the accumulator of a hydraulic system as the main chassis of the vehicle overcomes one of the major issues for the implementation of hydraulics, the large weight per unit of stored energy. At the same time this development allows for much larger accumulators, as the accumulator weight is no longer an issue. This new available dimension allows for periods of operation without the prime mover running, saving a large portion of fuel and emissions, as engines and electric motors consume unloaded about 40% of the maximum consumption or current in the case of the electric motors.

When the prime mover is running, it will do so at the maximum torque with the proper rpm, it's most efficient point. If the operation does not need fully this power, the secondary pump will be reloading the accumulator with that available energy. The hydraulic motors will do the same when braking. The prime mover then, when running, will do so only at its optimum efficiency almost all the time.

When more torque is needed at the wheels, mainly for acceleration, the accumulator flow will open to the inlet of the power integrator, helping the prime mover to accelerate the vehicle. Of course, the consequence of this arrangement enables the use of smaller prime movers for the same weight and acceleration vehicles. If the pressure coming from the accumulator is too high, the secondary pump will then send the extra energy from the prime mover back to the accumulator. In some cases, we could have several settings for the speed of the prime mover: let's say urban traffic (low), freeway (middle) and mountain (faster).

The coordination of the operation of the system is done with computer and copyrighted software. One version of the controls allows for the use of one pedal or joystick to control speed, direction, acceleration and braking and with a joystick one can add steering, for a vehicle much simpler to control and much safer to operate. The infinite automatic transmission allows for an even better efficiency and lower emissions.

### BRIEF DESCRIPTION OF THE SEVERAL VIEWS OF THE DRAWINGS

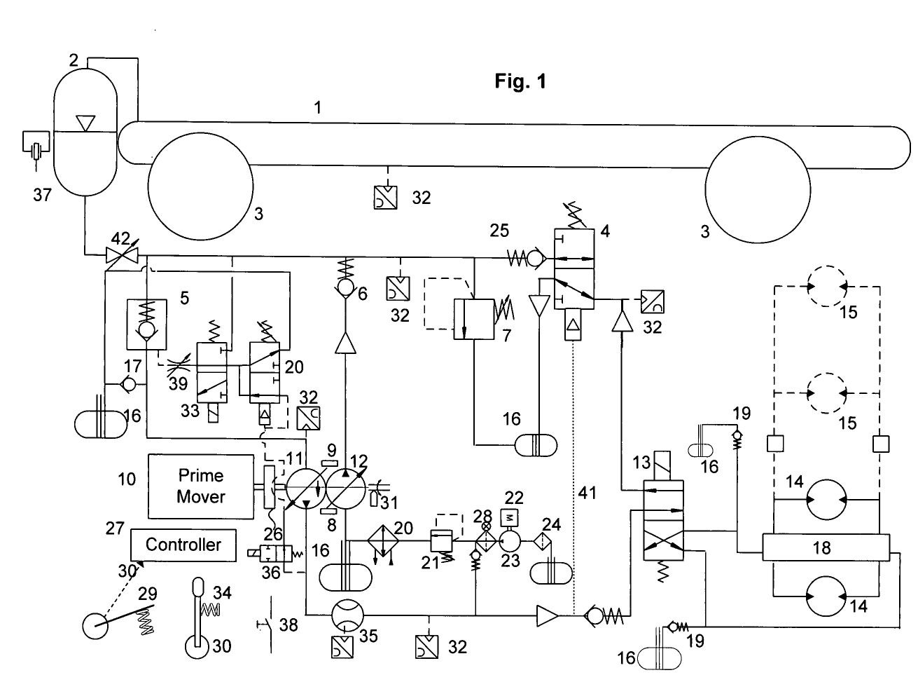

Sheet 1, FIG. 1: Proposed version of a complete hydraulic schematics, including the accumulator. Some less important devices are not shown.

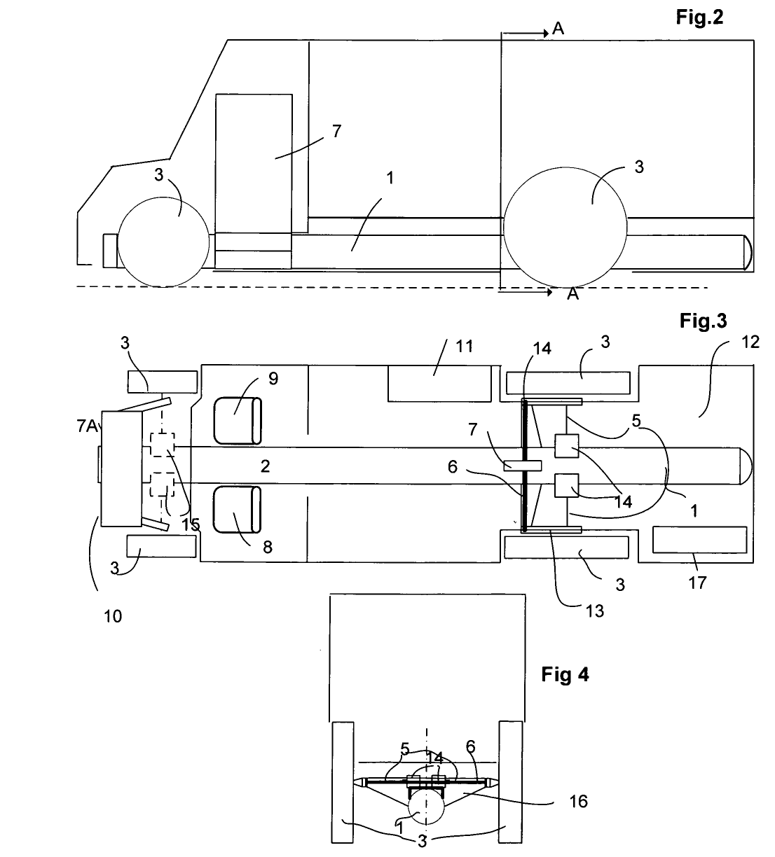

Sheet 2, FIG. 2: Side view of a commercial Van, using the new arrangement as one example of the multiple applications, for clarification purposes.

Sheet 2, FIG. 3: Top view of same

Sheet 2, FIG. 4: Cutaway AA from FIG. 2.

### DETAILED DESCRIPTION OF THE INVENTION

The preferred embodiment of the present invention is contained in FIG. 1. FIGS. 2, 3 and 4 there are just a description of a vehicle sample application of the preferred embodiment of the system on a commercial Van, UPS type.

FIG. 1 depicts the preferred embodiment of the hydraulic circuit, indicating schematically an accumulator 1, the gas container, which at the same time, is the chassis of the vehicle. The oil/gas accumulator 2 could be separated from accumulators or could be installed inside accumulator 1.

The prime mover 10 is connected via a unidirectional coupling 26 to a special unidirectional variable power integrator 11 and in the same shaft, to a unidirectional variable flow pump 12. This unidirectional coupling is required to allow for the operation of the system when the prime mover is not running. Pump 11 is controlled by servo valve 9 and pump 12 is controlled by servo valve 8. Both servo valves receive the proper signals from the controller 27. The accumulator 2 has an electronic oil level indicator that signals the amount of oil in the accumulator 2 to the controller 27. If the amount of oil is large, the signal to start the system will not launch the prime mover 10. If the signal indicates a low amount of oil in the accumulator 2, the prime mover will automatically be started.

Once the prime mover 10 is running, power integrator 11 and pump 12 will have zero flow initially. Pump 12 will flow immediately after, charging the accumulator with the available torque from prime mover 10, via check valve 6, taking oil from tank 16. Pump 11, once it receives a signal to go to a certain flow, will take oil from tank 16, via check valve 17 and send oil to the hydraulic motors 14(and 15 if so built) via flowmeter 35, check valve 40, solenoid valve 13(only one version shown) and controlling block 18. The block 18 will have functions like relief valves, differential control effects, flow sharing, etc. The flow will be the same independent of the pressure. There are two anticavitation valves 19 than could be part of block 18 that go to tank 16. Pilot line 41 goes to a pilot operated three way, two position valve 4. When the pressure on line 41 reaches a certain value, valve 4 will open the output of the hydraulic motors to tank 16. On a generating mode, valve 4 sends the output flow of the motors 14 (and motors 15) via check valve 25 and valve 42 to the accumulator 2. If the accumulator 2 reaches a certain pressure, oil is discharged back to tank via relief valve 7 or to the inlet of the pump 11. Valve 42 is just a service valve that isolates the accumulator for safety purposes. The safety and/or auxiliary brakes are not represented here,

If the output pressure of pump 11 reaches a certain threshold, a pilot line goes thru solenoid valve 36 (two way, two position) to pilot valve 20—three way, two position valve. The output of valve 20 goes through solenoid valve 33—three way, two position valve—and controlled orifice 39 to pilot open check valve 5. This action connects the high pressure accumulator to the inlet of power integrator 11, to allow for an elevated pressure at the output, obtaining higher accelerations of the vehicle with a much smaller engine. The accumulator flow is the main output flow of power integrator 11 and is controlled but said device 11. Any over speed of the prime mover—known via speed sensor 31—makes pump 12 send the extra energy back to the accumulator and in so doing, controlling over speed.

When the prime mover is not running because enough energy is stored in the accumulator, we will describe the new running mode: Solenoid valve 36 is energized, closing the pilot line to the pilot operated valve 20. Solenoid valve 33—three way, two position valve—is energized opening the accumulator 2 via check valve 5, to the inlet of power integrator 11. The speed of the vehicle—meaning the output flow of power integrator 11—will be controlled by the swash plate position of said power integrator 11 and same for pump 12.

Pedal 29 or Joystick 34, command a position sensor 30 that signals to the controller what speed is the one desired, and what acceleration or braking rate is required. Internal controls limit both the acceleration and braking or deceleration rate to a given maximum. Switch 38 is a one-off switch to allow for reverse operation when needed. Both the pedal 29 and Joystick 34 go to zero output when released. If, at that point, prime mover 10 is running, it will continue running only until the accumulator 2 is full, loading it via pump 12 and servo control 8. In that condition, power integrator 11 is not creating any output flow; hence the vehicle is at a standstill. If the Joystick 34 is supplied with an auxiliary position sensor for lateral movement, then we have a Joystick able to additionally control steering. This is not applicable to vehicles running on rails, but all the other functions are. Several pressure transducers 32 allow for the controller to know the instantaneous pressure in several part of the hydraulic circuit, and react properly for the operation and safety of the vehicle.

Some auxiliary hydraulic functions could be described here. Charge pump 23 is a low flow, low pressure pump powered by small electric motor 22. Charge pump 23 could also be powered by main shaft of prime mover, mounted after pump 12. Suction filter 24, coming from tank 16, gets the flow to the inlet of pump 23, output of pump 23, goes to filter 18, relief valve 21, cooler 20, back to tank 16.

We are now on sheet 2 with FIGS. 2, 3 and 4. FIG. 2 is a depiction of a side view of a commercial Van, type UPS. One can see the position of the accumulator 1 as the chassis for the vehicle. Wheels 3 are also depicted, with larger diameters than the classical Vans. One can also see the door or doorway 7.

FIG. 3 is a top view of the Van. You can see again the accumulator 1, and the wheels 3. The oil accumulator 2 is inside the main accumulator 1. Independent hydraulic motors 14 propel wheels 3 via universal joints 5. Suspension consist on leveling supports 13, rotating in a vertical plane, pivoting on support 14. Both pivots are connected via a torsion bar 6, and the suspension 7 is common to both wheels through the torsion bar. For a four wheel drive system, motors 15 are shown for the front wheels and suspension 7A is also shown. The power unit 10 consists of the prime mover and all Hydraulics as well as all mechatronics involved. The hydraulic tank or reservoir 11 is indicated in its position. The driver seat 8 and assistant or trainee seat 9 are sketched on FIG. 3. Gas tank 17, or CNG bottles 17 are also provisionally located on FIG. 3.

The FIG. 4 is a cutaway AA of FIG. 2, to help understand better the sample design. We can see the structural support 16, that hold pivot 14, attached to chassis 1, as well as torsion bar 6 and universal joints 5.

What I claim as my invention is:

1. A hybrid hydraulic series system that will automatically send the required hydraulic flow at any pressure to the hydraulic propulsion motors according to an electric signal, using any ICE, electric motor, turbine, fuel cells, etc. as the prime mover.

2. The hybrid hydraulic system as defined in claim 1 that recharges the accumulator with the extra power available from the engine or electrical motor when they are running.

3. The hybrid hydraulic system defined in claim 1, which allows running the vehicle without the main power source on, under full speed control using the energy needed from the accumulator.

4. The hybrid hydraulic system defined in claim 1, using a unidirectional coupling from the prime mover to the main pump allowing torque transmission only in one direction.

5. The hybrid hydraulic system defined in claim 1, that carry an auxiliary pump for ancillary services, propelled by an electric motor with power supplied from the battery or the mains.

6. The hybrid hydraulic system defined in claim 1, where the auxiliary pump mentioned in claim 5 is now directly connected to the shaft of the prime mover, together with the power integrator and the accumulator recharge pump.

7. The hybrid hydraulic system defined in claim 1, whereas the driver interface is one foot pedal or joystick to control speed, acceleration and braking. Steering could also be included with the joystick when applicable.

8. The hybrid hydraulic system defined in claim 1. Whereas the braking energy is passed to the accumulator. If the accumulator is full, the prime mover is stopped and the vehicle continues its operation with the energy of the accumulator. The prime mover is restarted automatically when the accumulator reaches a lower set value.

9. The hybrid hydraulic system defined in claim 1, whereas the hydraulic motors are of the piston type, single or double flow capacity, connected in series and/or parallel.

10. The hybrid hydraulic system defined in claim 1, whereas the hydraulic motors have slippage and ABS controls, and the non powered wheels have also brakes with ABS.

11. The hybrid hydraulic system defined in claim 1, whereas for higher speed vehicles, the hydraulic motors are mounted on the chassis and not directly on the wheels, connected to them with universal joints.

12. The hybrid hydraulic system defined in claim 1, whereas for lower speed applications, meaning no suspension exist, the hydraulic motors are part of the wheel.

13. The hybrid hydraulic system defined in claim 1, whereas the special unidirectional variable flow pump 11 is defined as a power integrator as it could receive high pressure flow at the inlet, plus the prime mover mechanical input.

14. The hybrid hydraulic system defined in claim 1, whereas a secondary unidirectional variable flow pump on the same shaft than the power integrator, recharges the accumulator if the prime mover or/and the accumulator, have extra torque at their optimum operation.

15. The hybrid hydraulic system defined in claim 1, whereas the software sets a maximum acceleration rate and a minimum braking rate. The operator can choose a slower acceleration than the one set up, as well as a slower braking rate by moving the pedal or joystick at a lower rate of position change.

16. The hybrid hydraulic system defined in claim 1, whereas the ICE prime mover has several speed settings for different applications. The settings are such that any new setting will create a new constant rpm and the system will use close to the maximum power of the ICE.

17. The hybrid hydraulic system defined in claim 1, whereas the prime mover is much smaller than the equivalent prime mover with the same speed and acceleration in a similar vehicle.

18. The hybrid hydraulic system defined in claim 1, where applied to rail cars, each car will have his own motive power controlled by wireless, hence locomotives are eliminated and trains will be easily coupled and uncoupled.

19. A hybrid hydraulic system, whereas In all versions and applications, a large accumulator is the chassis of the different vehicles, such as automobiles, taxis, Vans, buses, trucks, subway, tramway, railroad cars, tractors, excavators, caterpillars, tanks, airplanes, forklifts, military gear, passenger cars, etc.

20. The hybrid hydraulic system defined in claim 19, where the material to be used for the accumulator could be standard or high tensile steel or aluminum, or high tensile strength plastic fiber.

21. The hybrid hydraulic system defined in claim 19, where the tubing form to be used is one or several large tubing or pipe, or smaller pipes or tubing welded together forming the vehicle chassis, or smaller pipes or tubing welded together like in a steam boiler.

22. The hybrid hydraulic system defined in claim 19, whereas a linear transducer sends a signal to the controller indicating the volume of oil in the accumulator.
